(19) United States
(12) Patent Application Publication
(10) Pub. No.: US 2007/0186207 A1
(43) Pub. Date: Aug. 9, 2007

(54) Method and apparatus for printing patterns with improved cd uniformity

(75) Inventor: Torbjorn Sandstrom, Pixbo (SE)

Correspondence Address: HAYNES BEFFEL & WOLFELD LLP, P O BOX 366, HALF MOON BAY, CA, 94019, US

(73) Assignee: Micronic Laser Systems AB, Taby (SE)

(21) Appl. No.: 10/579,511

(22) PCT Filed: Nov. 19, 2004
(86) PCT No.: PCT/SE04/01701

§ 371 Date: Mar. 30, 2007

Related U.S. Application Data
(60) Provisional application No. 60/524,076, filed on Nov. 20, 2003.

(51) Int. Cl. G06F 17/50; G02B 26/00

(52) U.S. Cl. 716/21; 359/291; 716/19

(57) ABSTRACT

An aspect of the present invention includes a method to pattern a workpiece with improved CD uniformity using a partially coherent electromagnetic radiation source. Said method including the actions of: determining, for a plurality of layers in said workpiece, CD uniformity as a function of a number of exposure flashes, determining, for the plurality of layers in said workpiece, the cost of patterning as a function of the number of exposure flashes, and selecting the number of exposure flashes on a layer by layer basis, which gives a predetermined CD uniformity corresponding to a preferred cost. Other aspects of the present invention are reflected in the detailed description, figures and claims.

### FIELD OF THE INVENTION

The present invention relates to projection imaging, in particular to microlithography by projection of an image from a mask/reticle or at least one spatial light modulator.

### BACKGROUND OF THE INVENTION

Current demands for high density and performance associated with ultra large scale integration in semiconductor devices require submicron features, increased transistor and circuit speeds, and improved reliability. Such demands require formation of device features with high precision and uniformity, which in turn necessitates careful process monitoring.

Projection of images being illuminated by multimode lasers, often give rise to micro-non-uniformities emanating from the coherence of the light source together with roughness and aberrations of the surfaces along a light path. The image formed by each mode or quasimode gives an image with high-contrast speckle. The speckle pattern is a fine-grained random variation in illumination, different from mode to mode, flash to flash, giving a noisy pattern over said image to be patterned. Speckle causes unpredicted signal non uniformities, thus making it harder to pattern fine features with CD-uniformity.

In lithography the light sources used have a large number of longitudinal and lateral modes in order to average out the speckle. A comprehensive description of speckle phenomena can be found in T. S. McKechnie, Speckle Reduction, in Topics in Applied Physics, Laser Speckle and Related Phenomena, 123(J. C. Dainty ed., 2d ed., 1984).

The inventor has found that this averaging is often insufficient. A state-of-the-art scanner for printing semiconductor devices typically uses an ArF laser with 193 nm wavelength and a pulse time of 30-60 ns and a bandwidth of 0.2 picometers. Every feature is illuminated with 20-40 laser flashes through a lens with NA=0.75 or higher. The inventor has found that speckle in such scanners may give rise to a size variation of 6 nm (3 sigma) on a contact hole layer. This is comparable to the entire size error budget for the contact layer and highly undesirable. As can be appreciated from the forgoing discussion, there is a need in the art for a method for reducing speckle when patterning a workpiece (wafer, mask, reticle, etc.) using partially coherent electromagnetic radiation sources of any wavelength.

### SUMMARY OF THE INVENTION

An aspect of the present invention includes a method and device to reduce the magnitude of the residual speckle in laser pattern generators.

In another aspect the present invention applies to image projection using multimode lasers, in particular excimer and molecular lasers such as XeCl, KrF, ArF, and F2 lasers.

In yet another aspect of the invention the speckle is reduced when patterning only some of the layers forming a microelectronic device.

Other aspects of the present invention are reflected in the detailed description, figures and claims.

### BRIEF DESCRIPTION OF THE DRAWINGS

FIG. 1 depicts laser speckle illumination and small features.

FIG. 2 depicts an inventive procedure to optimize CD uniformity vs. throughput.

FIG. 3 depicts illumination uniformity vs. bandwidth, pulse time, and number of laser pulses for a non-polarised imaging system.

FIG. 4 depicts illumination uniformity vs. bandwidth, pulse time, and number of laser pulses for a polarized maskless system.

FIG. 5 depicts a schematic view of an embodiment of a pattern generator according to prior art.

FIG. 6 depicts a wafer scanner according to prior art.

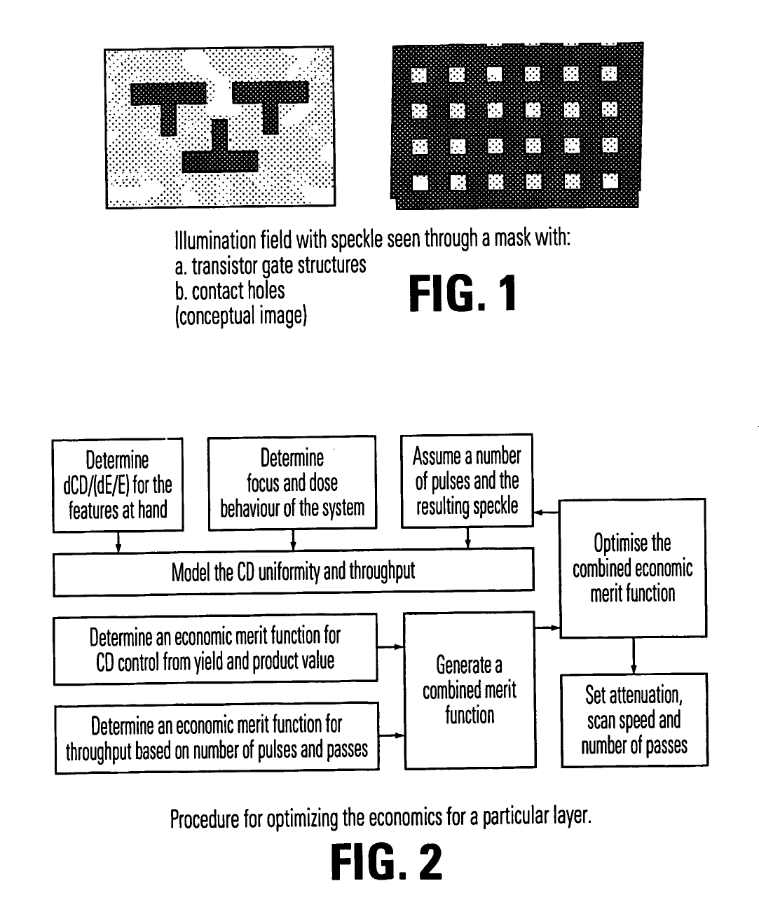

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

The present invention particularly applies to the exposure of wafers to form electronic devices by projection of photomask images, exposure of mask blanks to produce masks by projection of precursor masks, and to the exposure of wafers and masks blanks by projection of the image from a spatial light modulator. It also applies to projection of mask or SLM images onto other substrates for the creation of diffractive optical devices, integrated optical devices, thin-film heads, high density interconnection devices, MEMS devices, PCBs, MCMs, optical security devices, visual display devices and other similar devices.

The inventor has found that the critical factor is the product of laser bandwidth, laser pulse length, number of pulses and number of polarization states being larger than a number that depends on the wavelength, the MEEF factor, and the allowable line width variation due to speckle. This finding allows a layer-by-layer trade-off between through-put and printing fidelity. Lowering speckle on critical layers gives tighter CD control. High-speed logic such as microprocessors can be clocked at a higher speed or they can be designed with smaller features since better illumination uniformity allows printing at lower contrast. A design for 65 nm design rule may be shrunk to 60 nm, or alternatively the operating clock frequency may be raised by a few percent without redesign if low-speckle imaging is used.

One embodiment is a wafer scanner with 193 nm wavelength and NA equal to or larger than 0.85 similar to wafer scanners available on the market, such as AT-1250 from ASML, but differs in a number of aspects.

A wafer scanner according to prior art is illustrated in FIG. 6. The apparatus comprises a radiation source 1, for example an excimer laser, emitting radiation pulses at an exit window 2. The exit window may be the exit plane of an optical integrator, for example a quartz rod as shown.

The integrator forms an even intensity distribution over the exit window. The exit window may have an elongated shapeo An imaging system 3 comprises in this embodiment three lenses 3′, 3″and 3′″, images the exit window on a surface of a mask or a reticle 5 having a pattern. A linear actuator 6, for instance, scans the mask 5 relative to the window image in such a way that the entire pattern provided on the surface 4 is illuminated. Alternatively the mask 5 may be stationary and the exit window 2 scanned. The long direction of the image of the exit window on the mask is perpendicular to the scan direction, i.e., the direction in which the linear actuator 6 displaces the mask 5 during the exposure to the pulsed radiation. The elements numbered 1 to 6 form a scanning slit exposure device.

A projection lens system 7, schematically indicated in the figure by a single component, images the illuminated part of the mask 4 onto a radiation sensitive layer 8 arranged on a substrate 9. The substrate may be a semiconductor wafer. The projection lens system 7 may have a magnifying power of ¼. The substrate is scanned by a second linear actuator 10, for instance, synchronously with the scanning of the mask 5 taking into account the magnifying power of the projection lens system 7. A controller 13 controls the radiation source. The controller 13 determines the number of radiation pulses with which a field on the radiation sensitive layer 8 should be irradiated in order to achieve the required exposure dose.

The scanning slit width is wider: 12 mm instead of 6 mm. This increases the number of pulses to form a feature.

The laser bandwidth is wider: not 0.25 pm or less but 0.5 pm or higher. This necessitates a lens with improved chromatic correction. Such lenses can be built with one or more diffractive lenses. Diffractive lenses have a dispersion much higher than refractive lenses, and of the opposite sign. Therefore weak diffractive lenses are powerful for correction of chromatic aberrations. The combination of weak aspheric diffractive lenses and refractive aspheres give improved aberration control and significantly improved chromatic correction, at the same time as allowing simplification of the design. With diffractive lenses the bandwidth can be increased significantly, at least ten times higher than for a refractive design. The 0.5 pm bandwidth given above may be obtained with a refractive design using a mixture of materials, but with diffractive elements a 5 pm bandwidth is feasible for an optical field of 20-26 mm. This applies to refractive and refractive-diffractive lenses. Catadioptric lenses can be built with higher bandwidth since a large part of the power is in one or several mirrors and the mirrors have no chromatic aberrations.

Furthermore the laser pulse is longer than 50 ns, and in one embodiment the pulse length is 200 ns. This is accomplished by splitting the pulse, delaying part of it, and recombining. This type of pulse stretching is known in the art and is used in excimer lasers, e.g. XLA laser from Cymer, to reduce the peak power. However, the pulse stretching in this application is larger and has two cascaded stretching delay loops, one with loop time 50 ns and one with loop time 125 ns to create a 200 ns pulse time from a 50 ns commercial laser. The delay loops are formed in a purged tube mounted below the floor of the clean room between the laser and the scanner.

One embodiment has a laser with pulse repetition rate of 6 kHz instead of customary 4 kHz.

One embodiment has a laser power control to be used for CD optimization. A variable attenuator gives a transmission of 25-100% and the laser output can be controlled electronically from 50-100%.

The wafer scanner has software support for optimizing the CD vs. throughput on a layer-to-layer basis.

The above disclosed features in combination with the different embodiments may give 5 times less speckle than a comparative scanner in prior art. Further improvement can be obtained with the optimization procedure, essentially trading speckle suppression vs. throughput as described further below.

Another embodiment has two lasers to achieve a combined interlaced pulse rate of 12 kHz.

For each layer a CD uniformity target is defined. The MEEF value is determined by analysis, simulation or experiment, or alternatively the dCD/(dE/E) factor is determined. The dose and focus performance of the scanner is input to a model calculating the resulting CD uniformity. The effect of speckle with standard settings is added. If the CD uniformity target is satisfied the procedure ends. Otherwise the speckle contribution is reduced through attenuation of the laser power and reduction of the scan speed. If a reduction of two or more is needed, the single slow scan is replaced by two scans per field. The field is scanned twice, once in each scanning direction. This gives an averaging of other errors than speckle as well, improving CD uniformity further. More scans than two can be used if necessary. The multi scan procedure can be used with or without realignment of the wafer and reticle, the choice depending on the exact error structure. Realignment gives better total alignment performance, but may have an adverse effect on CD uniformity through increased fading.

In the normal case there is not a satisfaction target for CD uniformity on critical layers, but CD uniformity should be optimized. On the other hand, the procedure allows for a large improvement in CD uniformity but at the penalty of unacceptable throughput. The joint optimization may be done by building a merit function for the CD uniformity representing the improvement in yield and/or device value, and a similar merit function for throughput and optimizing the combined merit function.

One embodiment has computer software for doing this optimization: calculating target CD uniformity of the layers and merit functions for them based on device performance and yield, modeling the CD performance of the scanner including the effect of speckle, modeling the throughput and deriving merit functions for the throughput, and optimization of the combined merit function. Furthermore there is software for decreasing scan speed, changing the laser power to keep the exposure dose at the intended value, and to generate multiple scan cycles if the needed number of flashes is high enough to allow it.

It is believed that this procedure will, even with current tools without the hardware changes described above, improve production economy and device value. For a microprocessor the CD uniformity of the poly-silicon layer is the most critical and determines the clocking speed and selling price of the finished devices. Finding an exposure setting with 50% less laser power, 50% lower scan speed and/or possibly double exposure cycles per field will improve CD uniformity by reduction of the speckle and more averaging. It will give less throughput for this single layer, but improved device performance and higher product value.

The rms illumination variation due to speckle can be calculated as

S=1/sqrt(Pulse length/Coherence time * Number of pulses * Number of polarizations)

The pulse length (really the pulse time) is measured in nanoseconds. The coherence time is calculated from the laser bandwidth and the wavelength and can be found in most textbooks on lasers. The number of pulses is the number of pulses hitting a single location on the wafer. The number of polarizations is 1 for polarized and 2 for un-polarized light.

If the laser spectrum or pulse shape is much different from Gaussian equivalent pulse length and coherence time values may need to be computed using the actual shapes. Likewise if the pulses do not have equal energy an equivalent pulse number should be derived. In most cases the corrections would be small. They should pose no problem to a worker educated in laser physics. A formula for equivalent degrees of freedom (here number of polarizations) in a partially polarized beam can be found in Goodman: Statistical Optics.

Another embodiment is a maskless scanner for direct-writing of integrated circuits on silicon wafers. Instead of a reticle is has an SLM driven by a data path. Such a system has been described in a previous patent application by the same inventor.

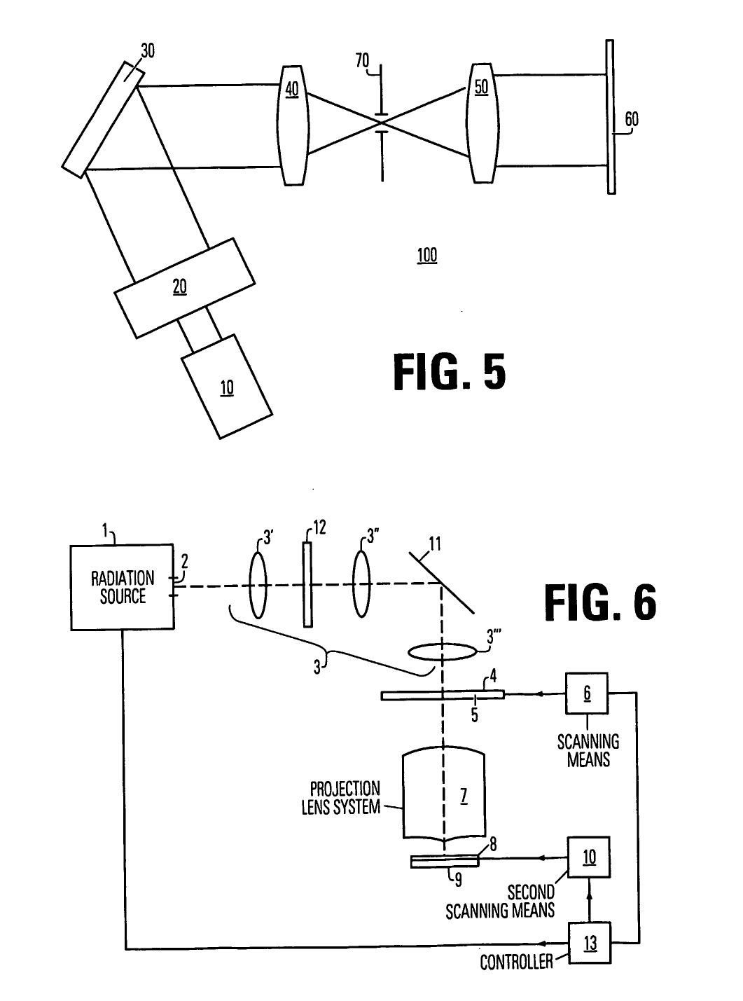

FIG. 5 illustrates an embodiment of an apparatus 100 for patterning a work piece 60 according to prior art, into which the present invention could easily be inserted.

Said apparatus 100 comprising a source 10 for emitting electromagnetic radiation, an objective lens arrangement 50, a computer-controlled reticle 30, a beam conditioning arrangement 20, a spatial filter 70 in a Fourier plane, a Fourier lens arrangement 40 and said work piece 60.

The source 10 may emit radiation in the range of wavelengths from infrared (IR), which is defined as 780 nm up to about 20 μm, to extreme ultraviolet (EUV), which in this application is defined as the range from 100 nm and down as far as the radiation is possible to be treated as electromagnetic radiation, i.e. reflected and focused by optical components. The source 10 emits radiation either pulsed or continuously. The emitted radiation from the continuous radiation source 10 can be formed into a pulsed radiation by means of a shutter located in the radiation path between said radiation source 10 and said computer-controlled reticle 30. For example, the radiation source may be a KrF excimer laser with a pulsed output at 248 nm, a pulse length of approximately 10 ns and a repetition rate of 1000 Hz. The repetition rate may be below or above 1000 Hz.

The beam conditioning arrangement 20 may be a simple lens or an assembly of lenses. The beam conditioning arrangement 20 distributes the radiation emitted from the radiation source 10 uniformly over a surface of the computer-controlled reticle 30. In case of a continuous radiation source a beam of such a source may be scanned over the surface of the computer-controlled reticle.

Workpiece 60 is moved in a systematic fashion so that the optical system synthesizes the desired device layer pattern.

The computer-controlled reticle 30 may be a Spatial Light Modulator (SLM). In this embodiment the SLM comprises all information at a single moment that is required to pattern a certain area of the workpiece 60.

For the remainder of this application an electrostatically controlled micro mirror matrix (one- or two dimensional) is assumed, although other arrangements as described above are possible, such as transmissive or reflective SLMs relying on LCD crystals or electro-optical materials as their modulation mechanism, or micromechanical SLMs using piezoelectric or electrostrictive actuation.

The SLM 30 is a programmable device that produces an output radiation beam that is modulated by separate inputs from a computer. The SLM 30 simulates the function of a mask through the generation of bright and dark pixels in response to computer fed data. For example the phase SLM 30 is an array of etched solid state mirrors. Each micromirror element is suspended above a silicon substrate by restoring hinges, which may be supported either by separate support posts or by the adjacent mirrors. Beneath the micromirror element are address electrodes. One micromirror represents one pixel in the object plane. The pixel in the image plane is here defined as to have the same geometry as the micromirror but the size may be different due to the optics, i.e. larger or smaller depending on whether the optics is magnifying or demagnifying.

The micromirror and the address electrodes act as a capacitor so that for example a negative voltage applied to the micromirror, along with a positive voltage to the address electrode, will twist the torsion hinges suspending the micromirror which in turn allow the micromirror to rotate or to move up or down, thereby creating a phase modulation of the reflected light.

A projection system comprises in this embodiment the Fourier lens arrangement 40, which may be a compounded tube lens, the spatial filter 70 and the objective lens arrangement 50. The Fourier lens arrangement 40 and the spatial filter 70 form together what is generally called a Fourier filter. The Fourier lens arrangement 40 projects the diffraction pattern onto the spatial filter 70. The objective lens arrangement 50, which may be a compounded final lens, forms the aerial image on the work piece 60.

The spatial filter 70 is in this embodiment an aperture in a plate. Said aperture being sized and positioned so as to block out essentially all light which is diffracted into the first and higher diffraction orders, for example said aperture may be located at the focal distance from the Fourier lens arrangement 40. The reflected radiation is collected by said Fourier lens arrangement 40 in the focal plane, which acts at the same time as a pupil plane of the objective lens arrangement 50. The aperture cuts out the light from the first and higher diffraction orders of the addressed micromirrors in the SLM, while the radiation from the non-addressed mirror surfaces can pass the aperture. The result is intensity modulated aerial image on the work piece 60 as in conventional lithography.

One embodiment has six SLMs in the same optical field, each SLM having 2048×5120 tilting mirror elements 8×8 microns in size. The projection lens is catadioptric with a wafer plane optical field of 0.9 mm, and the demagnification is 267 times so each mirror corresponds to a 30×30 nm pixel on the wafer. The image is formed with only two pulses. The light hitting the wafer is polarized. The illumination is a partly narrowed ArF laser with 10 pm bandwidth and 30 ns pulse time. In a second embodiment the bandwidth is 14 pm, in a third it is 20 pm, in a fourth 40 pm. A fifth embodiment has a laser pulse length of 20 ns, a sixth one 40 ns, and a seventh one 50 ns. An eighth embodiment uses non-polarized light.

The maskless scanner has the same means for attenuating the laser power and increasing the number of flashes as has been described above in connection with the wafer scanner. The amount of speckle generated is predicted and the number of pulses is increased in a trade-off between the value of CD control and throughput.

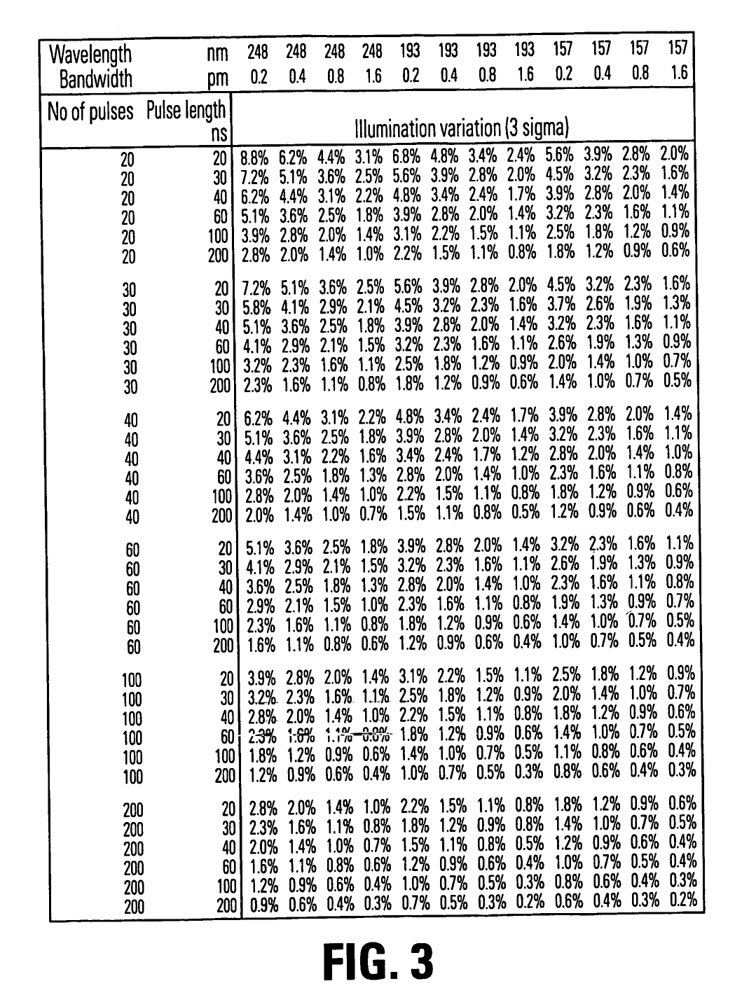

FIG. 3 shows illumination uniformity vs. bandwidth, pulse time, and number of pulses for a non-polarized imaging system. For polarized systems the speckle is multiplied by 1.41.

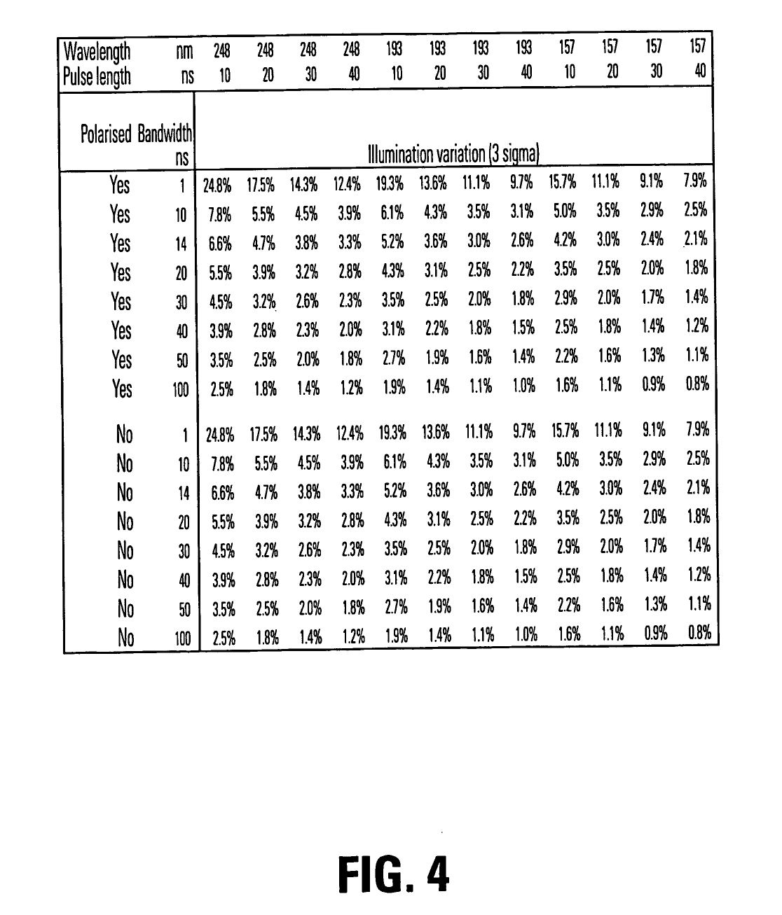

FIG. 4 shows speckle values for a maskless system using two pulses. For N pulses the speckle is multiplied by sqrt(2/N).

A cost of patterning the workpiece is related to the time it takes for producing the same.

While the present invention is disclosed by reference to various embodiments and examples detailed above, it is understood that these examples are intended in an illustrative rather than in a limiting sense. It is contemplated that modifications and combinations will readily occur to those skilled in the art, which modifications and combinations will be within the spirit of the invention and the scope of the following claims.

1. A method to pattern a workpiece with improved CD uniformity using a partially coherent electromagnetic radiation source having a speckle pattern which is a fine grained random variation in illumination different from mode to mode and/or flash to flash, including the actions of:
determining, for a plurality of layers in said workpiece, CD uniformity due to said speckle as a function of a number of exposure flashes,
determining, for a plurality of layers in said workpiece, the cost of patterning as a function of the number of exposure flashes,
selecting the number of exposure flashes on a layer by layer basis, which gives a predetermined CD uniformity corresponding to a preferred cost.

2. The method according to claim 1, further comprising the action of:
selecting a combination of values of the following parameters:
radiation bandwidth
pulse length
radiation flash frequency so that a calculated illumination non-uniformity (3 sigma) from speckle amounts to less than 0.5%.

3. The method according to claim 2, further comprising the action of:
determining a value of a slit width so that a calculated illumination non-uniformity (3 sigma) from speckle amounts to less than 0.5%.

4. A computer assisted apparatus for printing a workpiece with improved CD uniformity by using a partially coherent radiation source having a speckle pattern which is a fine grained random variation in illumination different from mode to mode and/or flash to flash, comprising:
logic and resources that determine, for a plurality of layers in said workpiece, CD uniformity due to said speckle as a function of the number of exposure flashes,
logic and resources that determine, for the plurality of layers in said workpiece, a cost of patterning as a function of the number of exposure flashes,
logic and resources that select the number of exposure flashes on a layer by layer basis, which gives a predetermined CD uniformity at a minimum of patterning cost.

5. A method for printing a workpiece with improved CD-uniformity by using a partially coherent radiation source having a speckle pattern which is a fine grained random variation in illumination different from mode to mode and/or flash to flash, including the action of:
changing a number of exposure flashes per surface element on a layer by layer basis.

6. A method for printing a workpiece with improved CD-uniformity by using a partially coherent radiation source having a speckle pattern which is a fine grained random variation in illumination different from mode to mode and/or flash to flash, including the action of:
changing a pulse length of exposure flashes per surface element on a layer by layer basis.

7. A method for printing a workpiece with improved CD-uniformity by using a partially coherent radiation source having a speckle pattern which is a fine grained random variation in illumination different from mode to mode and/or flash to flash, including the action of:
changing a radiation bandwidth of exposure flashes per surface element on a layer by layer basis.

8. A method for printing a workpiece with improved CD-uniformity by using a partially coherent radiation source having a speckle pattern which is a fine grained random variation in illumination different from mode to mode and/or flash to flash, including the action of:
changing a slit width of exposure flashes per surface element on a layer by layer basis.

9. The method according to claim 5, wherein said changing is performed for critical layers in the microelectronic device only.

10. A procedure to improve CD uniformity of a layer exposed in a scanner or stepper using partially coherent light having a speckle pattern, which speckle pattern is a fine grained random variation in illumination different from mode to mode and/or flash to flash, including the actions of:
providing a scanner system with an optical field larger than 10 mm,
increasing one or more of the following parameters
a. slit width,
b. laser bandwidth,
c. pulse length,
d. laser flash frequency,
e. number of flashes,
f. number of flashes per field,
g. number of scan cycles per field
until the calculated illumination non-uniformity (3 sigma) from said speckle amounts to less than 0.5%.

11. The procedure as in claim 10 but with calculated speckle less than 1%.

12. The procedure as in claim 10 but with calculated speckle less than 2%.

13. The procedure as claimed in claim 10 but with calculated speckle less than 3%.

14. The procedure according to claim 10, wherein non-polarised light is used.

15. The procedure according to claim 10, wherein refractive optics is used.

16. The procedure according to claim 15, wherein at least one diffractive element is used.

17. The procedure according to claim 15, wherein catadioptric optics with at least one diffractive element is used.

18. A procedure to improve CD uniformity of a layer exposed in a maskless scanner using partially coherent light having a speckle pattern which is a fine grained random variation in illumination different from mode to mode and/or flash to flash comprising the steps of:
providing a maskless scanner systems with an optical field larger than 0.5 mm,
increasing one or more of the following parameters:
a. laser bandwidth,
b. pulse length,
c. number of overlayed flashes,
until the calculated illumination non-uniformity (3 sigma) from said speckle amounts to less than 0.5%.

19. The procedure according to claim 18, wherein said calculated speckle is less than 1%.

20. The procedure according to claim 18, wherein said calculated speckle is less than 2%.

21. The procedure according to claim 18, wherein said calculated speckle is less than 3%.

22. The procedure according to claim 18, wherein non polarized light is used.

23. An apparatus for printing a workpiece with improved CD uniformity including:
logic and resources to calculate speckle, which speckle is a fine grained random variation in illumination different from mode to mode and/or flash to flash,
logic and resources that change the number of pulses per surface element on a layer to layer basis.

24. A procedure for optimizing speckle, which is a fine grained random variation in illumination different from mode to mode and/or flash to flash, during microlithographic printing including the actions of:
providing a model for the value of improved CD uniformity,
calculating the CD uniformity as a function of the number of flashes,
providing a model for the cost of printing with a particular number of pulses,
providing logic and resources that select a number of flashes that corresponds to a preferred result,
providing a control adapted to change the number of flashes, and
setting said approximately optimized number of flashes.

25. An electronic device with improved CD uniformity printed with speckle, which speckle is amounting from fine grained random variation in illumination different from mode to mode and/or flash to flash, less than 1% (3 sigma).

26. The method according to claim 23, further including the actions of:
determining, for a plurality of layers in said workpiece, CD uniformity as a function of a number of exposure flashes,
determining, for the plurality of layers in said workpiece, the cost of patterning as a function of the number of exposure flashes,
selecting the number of exposure flashes on a layer by layer basis, which gives a predetermined CD uniformity corresponding to a preferred cost.

27. The method according to claim 6, wherein said changing is performed for critical layers in the microelectronic device only.

28. The method according to claim 7, wherein said changing is performed for critical layers in the microelectronic device only.

29. The method according to claim 8, wherein said changing is performed for critical layers in the microelectronic device only.
